(19) United States
(12) Patent Application Publication
(10) Pub. No.: US 2014/0180717 A1
(43) Pub. Date: Jun. 26, 2014

(54) NON-TRANSITORY COMPUTER READABLE MEDIUM, MEDICAL CARE RECORD DISPLAY APPARATUS, AND MEDICAL CARE RECORD DISPLAY METHOD

(71) Applicant: FUJI XEROX CO., LTD, Tokyo (JP)

(72) Inventor: Makoto MIHARA, Kanagawa (JP)

(73) Assignee: FUJI XEROX Co., Ltd, Tokyo (JP)

(21) Appl. No.: 13/867,692

(22) Filed: Apr. 22, 2013

(30) Foreign Application Priority Data
Dec. 20, 2012 (JP) 2012-277893

(51) Int. Cl. G06F 19/00; G06Q 50/24

(52) U.S. Cl. CPC G06F 19/322; G06Q 50/24
USPC 705/3

(57) ABSTRACT

A non-transitory computer readable medium stores a program causing a computer to execute a process including searching a memory that stores medical care record information about each patient including information about a medical care region and a medical care date and time for each piece of medical care record information about a specified patient; and generating a distribution list image indicating distribution of the pieces of medical care record information. The generating generates the distribution list image in which a position distribution image and a time distribution image are arranged for display. The position distribution image has a position display mark arranged at each position corresponding to the medical care region on a body schema indicating a human body or part thereof. The time distribution image has a time display mark arranged at each position corresponding to the medical care date and time on a time axis.

### CROSS-REFERENCE TO RELATED APPLICATIONS

This application is based on and claims priority under 35 USC 119 from Japanese Patent Application No. 2012-277893 filed Dec. 20, 2012.

### BACKGROUND

(i) Technical Field

The present invention relates to a non-transitory computer readable medium, a medical care record display apparatus, and a medical care record display method.

(ii) Related Art

Paper documents and data of various types and various formats, such as paper documents including medical records, referrals, and various examination records, X-ray pictures, and video images and still images of endoscopic examinations, are stored in medical institutions including hospitals as records of medical examinations and medical treatments.

Systems that make databases of various documents and a variety of data for the medical care records and perform centralized management of the databases have been developed in recent years. In such a system, documents or the likes that meet a search condition specified by a user (a doctor who refers to the medical care records) are searched for and a list of the documents or the likes that have been searched for is presented to the user. For example, attribute information including the document name (linked to a data entity, such as the document or the like) representing each document resulting from the search, the date and time when the document has been registered and the person who has registered the document, and an attending doctor is displayed in the list. The user selects a document or the like which the user wants to read from the list and calls the entity data about the document to display the data about the document on the screen.

In the display of the list, it is necessary to identify each result of search from character information indicating the document name, the attributes, and so on. Accordingly, it is not necessarily easy to search for a necessary document.

### SUMMARY

According to an aspect of the invention, there is provided a non-transitory computer readable medium storing a program causing a computer to execute a process including searching a memory that stores medical care record information about each patient including information about a medical care region and a medical care date and time for each piece of medical care record information about a specified patient; and generating a distribution list image indicating distribution of the pieces of medical care record information that have been searched for. The generating generates the distribution list image in which a position distribution image and a time distribution image are arranged for display. The position distribution image has a position display mark that is associated with the medical care record information and that is arranged at each position corresponding to the medical care region in each piece of medical care record information that has been searched for on a body schema indicating a human body or part thereof. The time distribution image has a time display mark that is associated with the medical care record information and that is arranged at each position corresponding to the medical care date and time in each piece of medical care record information that has been searched for on a time axis.

### BRIEF DESCRIPTION OF THE DRAWINGS

Exemplary embodiments of the present invention will be described in detail based on the following figures, wherein:

FIG. 1 is a block diagram illustrating an exemplary configuration of a medical care record management system according to an exemplary embodiment;

FIG. 2 illustrates an example of the content of data in a medical care record management table;

FIG. 3 illustrates an example of the content of data in a patient information table;

FIG. 4 illustrates an example of the content of data in a specialty information table;

FIG. 5 illustrates an example of the content of data in a region information table;

FIG. 6 illustrates an example of the content of data in a document type information table;

FIG. 7 illustrates an example of how to display a search result screen;

FIG. 8 is a flowchart illustrating an example of a process of generating the search result screen;

FIG. 9 illustrates an example of how to display the search result screen in which a partial body schema is displayed; and

FIG. 10 illustrates an example of how to display the search result screen in which body schemas of multiple focus periods are displayed.

### DETAILED DESCRIPTION

Exemplary embodiments of the present invention will herein be described with reference to the attached drawings.

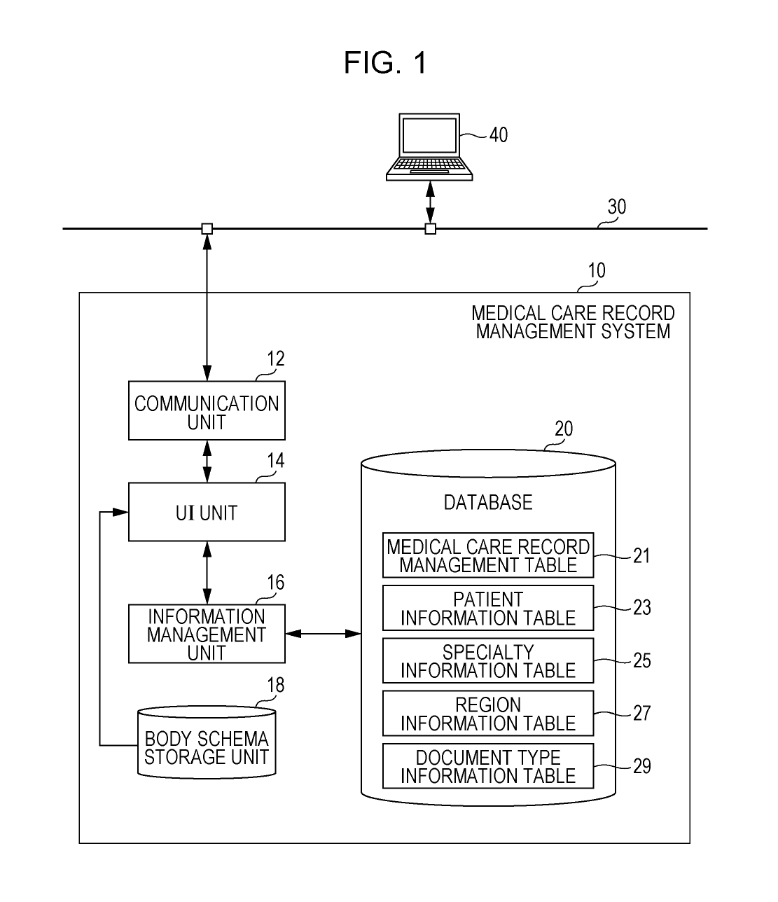

FIG. 1 is a block diagram illustrating an exemplary configuration of a medical care record management system 10 according to an exemplary embodiment. The medical care record management system 10 is connected to a network 30, such as a local area network (LAN) or the Internet. A user (for example, a doctor) accesses the medical care record management system 10 from a terminal 40 which the user (the doctor) operates via the network 30 to receive a service from the medical care record management system 10. The medical care record management system 10 may be operated in one medical institution, such as one hospital, may be commonly operated in multiple medical institutions, or may be operated as a more public system.

In the medical care record management system 10, a communication unit 12 controls data communication via the network 30.

A user interface (UI) unit 14 generates a UI screen and supplies the generated UI screen to the terminal 40 via the communication unit 12 and the network 30. The UI screen may be, for example, a Web page but is not limited to this.

The UI unit 14 has a function to generate a search result screen as an example of the UI screen. In the search result screen, medical care record documents of a target patient, which has been searched for by an information management unit 16, are plotted on a body schema and on a time line (time axis).

The body schema is a pictorial diagram indicating a human body or part of the human body described on a medical record or the like by the doctor and is used to record the location and the state of an affected area or the like. In the present exemplary embodiment, a body schema image representing the outline, the inside (for example, the arrangement of skeleton or viscera), or both of the outline and the inside of the entire human body, each part of the human body, or both of the entire human body and each part of the human body is prepared and an icon or a mark associated with each medical care record document that has been searched for is arranged and displayed on the corresponding region in the body schema image to inform the user which region in the body of the patient each document concerns. The “medical care record document” is hereinafter sometimes simply referred to as a “document” for simplicity.

Data on the body schema used for the display of the result of the search is stored in a body schema storage unit 18. The body schema that is stored indicates, for example, the entire human body. A partial body schema indicating an upper body, a lower body, a head, a chest, an abdomen, or the like may be registered in the body schema storage unit 18, in addition to or instead of the body schema indicating the entire human body. The body schema in which, for example, the front face of the entire human body or each part of the human body, the rear face thereof, or a side face thereof is schematically displayed is used for the display. A body schema in which, for example, the arrangement of internal organs and/or parts is displayed may be prepared, in addition to the body schema in which the appearance of the entire human body or each part of the human body is displayed, and the body schema in which the arrangement of internal organs and/or parts is displayed may be used for the display of the result of the search.

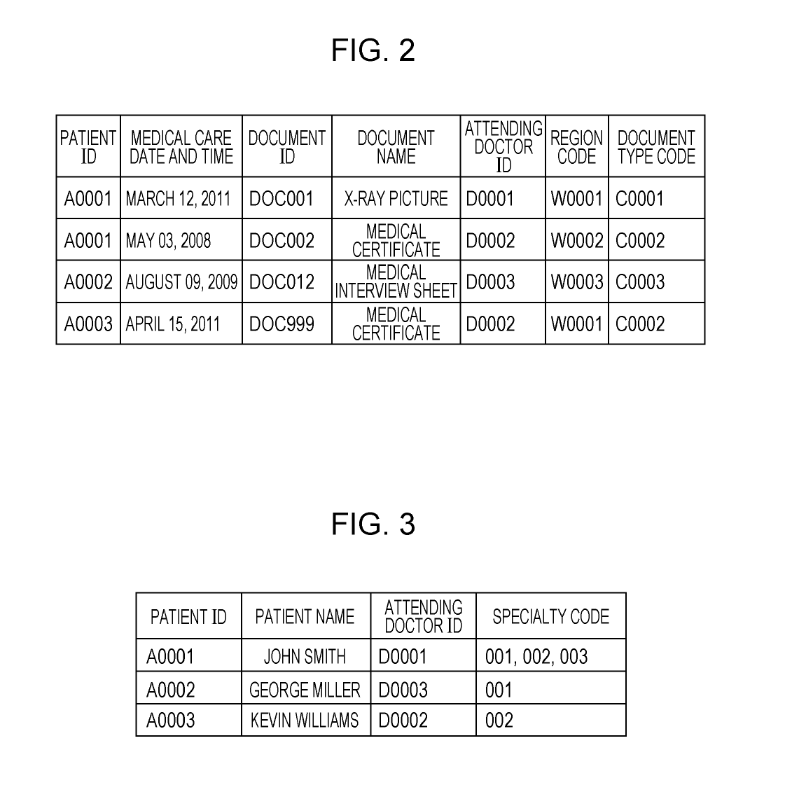

In time line display, the icon or the mark indicating each medical care record document is arranged and displayed at a position corresponding to the medical care date and time (refer to FIG. 2) corresponding to the medical care record document on the time line (time axis). For example, the length of the entire time line on the UI screen is used to represent the time width of a specified scale, such as several decades, about ten years, several years, or several months. The size of the time width of the entire time line and/or a start time, an end time, or both the start time and the end time of a period represented by the entire time line may be specified by the user.

The information management unit 16 manages a database 20 and searches the database 20 for a medical care record document, etc. in response to a request from the user.

The database 20 stores a variety of information for the management of the medical care record documents. Although the database 20 is composed of one system in FIG. 1, the database 20 may not necessarily be composed of one system. The database 20 may be composed of multiple subsystems that manage information which the subsystems have charge of.

The medical care record documents of each patient are accumulated in the database 20. The medical care record documents are electronic documents or data that are created in association with medical examinations and medical treatments of the patient and that are stored as records. The database 20 includes, for example, the documents or data of various types including medical records, examination reports, referrals (from other medical institutions), consent forms (for operations), medical interview sheets, X-ray pictures, video images captured by an endoscope. The data format of the medical care record documents is not specifically limited. The medical care record documents may have any format of a document file created by a document creation application, a scan document file including images, etc. captured by scanning a paper document, still image data, video image data, and multimedia data.

A medical care record management table 21, a patient information table 23, a specialty information table 25, a region information table 27, and a document type information table 29 are held in the database 20 as information used for the management and the use of the medical care record documents.

Management data about each medical care record document accumulated in the database 20 is held in the medical care record management table 21. FIG. 2 illustrates an example of the content of data in the medical care record management table 21. In a table illustrated in FIG. 2, the management data about one medical care record document is indicated in one row. In the example in FIG. 2, attribute items including a patient identification (ID) (identification information), a medical care date and time, a document ID, a document name, an attending doctor ID, a region code, and a document type code are included in the management data about one medical care record document.

The patient ID is the identification information for uniquely identifying a patient for whom the medical care record document is created. The medical care date and time indicates the date and time when the medical care corresponding to the document has been performed. Although the medical care date and time are represented in a year-month-day format in FIG. 2, the date and time may be recorded in a more detailed format, such as a year-month-day-hour format or a year-month-day-hour-minute format, or may be recorded in a year-month format. The document ID is the identification information for uniquely identifying a document. The entity data about the medical care record document is stored in the database 20 in association with the document ID. The document name is a name which the user has added to the document. The attending doctor ID is the identification information for uniquely identifying the attending doctor of the patient for whom the document is created. A creator ID indicating a person who has created (or registered) the document may be included in the management data, in addition to the attending doctor ID, in consideration of a case in which a person other than the attending doctor creates and registers the document. The region code is an identification code indicating a region for which the document is created, among the regions of the human body. A unique code is allocated to each region of the human body in advance and the code of the region corresponding to the medical care record document is selected from the codes. The medical care record document may not have a specific region associated therewith and no region code is set to such a document. The document type code is the identification code indicating the type of the medical care record document, such as the medical record, the examination report, the referral, or the X-ray picture.

The management data about the medical care record documents held in the medical care record management table 21, illustrated in FIG. 2, is only exemplified. The management data may not necessarily include all the attribute items exemplified above and may include attribute items other than the ones exemplified above. For example, medical care identification information may be automatically added for every first visit and the medical care identification information may be included in the management data. In this case, the medical care identification information added in the first visit is recorded in the management data about the document used in a medical action, such as a return visit, an examination, medication, or an operation after the first visit. This allows a series of documents from the first visit to cure for one symptom to be managed with the same medical care identification information.

The management data about each patient is held in the patient information table 23. FIG. 3 illustrates an example of the content of data in the patient information table 23. In a table illustrated in FIG. 3, the management data about one patient is indicated in one row, which includes items including a patient ID, a patient name, an attending doctor ID, and at least one specialty code. The patient ID and the attending doctor ID are described above. The patient name indicates the name of the patient corresponding to the patient ID. The specialty code is the identification code indicating each specialty which the patient has visited. The specialty code of a specialty that has created the document or that has registered the document in a database may be included in the management data about the medical care record document, although not illustrated in FIG. 2.

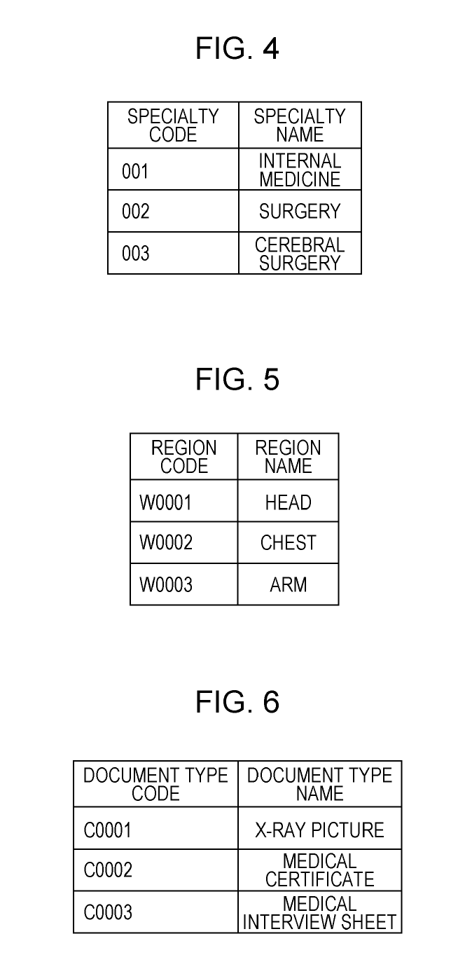

The management data about each specialty is held in the specialty information table 25. FIG. 4 illustrates an example of the content of data in the specialty information table 25. In a table illustrated in FIG. 4, the management data about one specialty is indicated in one row, which includes a specialty code and a specialty name. The specialty code is described above. The specialty name is the name of the specialty.

Definition information about each region code is held in the region information table 27. FIG. 5 illustrates an example of the content of data in the region information table 27. As illustrated in FIG. 5, the region name corresponding to each region code is registered in the region information table 27. For example, in the example in FIG. 5, a region code “W0001” is allocated to the “head” and a region code “W0002” is allocated to the “chest.” The regions including the “head” and the “chest” are associated with the positions of the regions on the body schema representing a human body, although not illustrated in FIG. 5. In an exemplary embodiment in which multiple kinds of body schemas including the body schema of the entire human body, the body schema of each part in the human body, and the body schema of the inside of the human body are used, the respective region codes are associated with the positions of the corresponding regions on each body schema.

The definition information about each document type code is held in the document type information table 29. FIG. 6 illustrates an example of the content of data in the document type information table 29. As illustrated in FIG. 6, the document type name corresponding to each document type code is registered in the document type information table 29. For example, in the example in FIG. 6, a code “C0001” represents a document type “X-ray picture (picture)” and a code “C0002” represents a document type “medical certificate.”

The tables illustrated in FIG. 2 to FIG. 6 are only exemplified. The tables may not necessarily include all the items exemplified above and may include items other than the ones exemplified above.

Each table exemplified above is called a table for convenience and may not have a table format as long as the table has a data format representing the content of similar information.

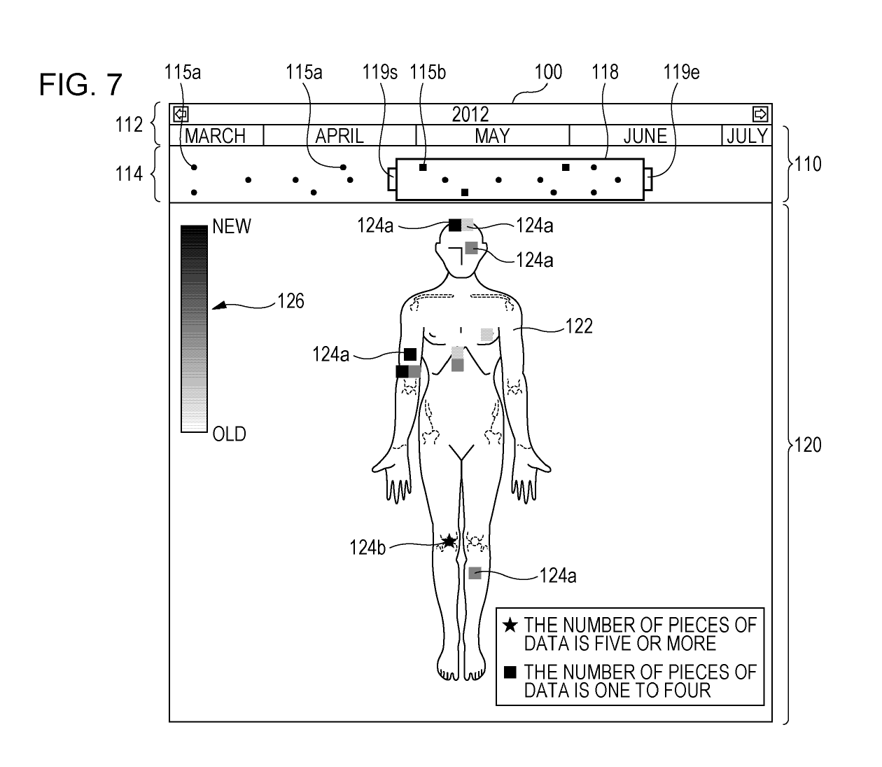

FIG. 7 illustrates an example of a search result screen 100 generated by the UI unit 14. A time line portion 110 and a body schema portion 120 are arranged on the search result screen 100 illustrated in FIG. 7.

In the example in FIG. 7, the time line portion 110 includes a time axis display field 112 and a search result display field 114.

The time axis display field 112 is a field in which the time axis representing the time flowing from left to right in FIG. 7 is displayed. A scale indicating which date and time or which period on a calendar each position or each period (or some typical positions or periods) on the time axis corresponds to is displayed in the time axis display field 112. In the example in FIG. 7, the time axis display field 112 is divided into two stages. An upper stage indicates the scale of years and a lower stage indicates the scale of months.

In the example in FIG. 7, the entire width of the time axis display field 112 represents some months in one year. However, the period represented by the entire width may be lengthened or shortened in response to an operation by the user. Alternatively, the period represented by the entire width of the time axis display field 112 may be shifted to a previous or subsequent period by a scrolling operation. For example, the time axis display field 112 may represent a latest period of a predetermined length from the current time to, for example, a time five years before using the entire width by default and the user may operate the scale size (the length of time represented by the entire width) or the display range (the time range represented by the entire width) while watching the display according to the default setting. The default setting of the display range of the time axis display field 112 is not limited to the latest period of a predetermined length. A period determined by another rule, for example, a shortest period including all the medical care dates and times of the documents that have been searched for may be set by default.

The search result display field 114 is a field in which the position of each document that has been searched for on the time axis represented by the time axis display field 112 is displayed. In the example in FIG. 7, the time axis display field 112 is divided into three stages (that is, three rows). One specialty (gastroenterological medicine, neurosurgery, orthopedic surgery, etc.) is allocated to each stage in the example in FIG. 7.

Time display marks (may be called icons) 115a and 115b indicating the respective medical care record documents that have been used (for example, that have been created or submitted) in the medical care in the corresponding specialty are arranged in one specialty stage. Each of the time display marks 115a and 115b is arranged at a position corresponding to the medical care date and time of the document represented by the corresponding mark on the time axis that horizontally extends. Which specialty each medical care record document is used in may be determined from the specialty code included in the management data about the document.

The user may specify how many stages (specialties) are displayed in the search result display field 114, which specialty is allocated to each stage in the search result display field 114, or both of how many stages (specialties) are displayed in the search result display field 114 and which specialty is allocated to each stage in the search result display field 114.

The time display mark 115a has a shape different from that of the time display mark 115b in the example in FIG. 7. The difference in attribute between the documents, such as the difference in the document type (the kind of the document) or the difference in the corresponding region, is indicated by the difference in shape. For example, when the document types are represented by the shapes of the time display marks 115a and 115b, the shape of the mark corresponding to each document type is determined in advance. Although the value of the attribute is represented by the shape of the mark in the example in FIG. 7, the representation method is only exemplified. The attribute may be represented by the display mode of another kind, such as the color of the mark, or the attribute may be represented by a combination of the display modes of multiple kinds, such as a combination of the color and the shape. Alternatively, a combination of multiple attributes of each document may be represented by the display modes of the mark corresponding to the document (for example, the corresponding region may be represented by the shape of the mark and the document type may be represented by the color of the mark).

Although the specialties are represented by the division into stages in the search result display field 114 and the document attributes other than the specialties are represented by the display modes of the time display marks 115a and 115b in the example in FIG. 7, the above representation method is only exemplified. Which attribute item of the document is associated with each stage resulting from the division or each display mode of the mark may be determined by, for example, a system manager or may be customized by each user. The division of the search result display field 114 into multiple stages is not necessarily performed.

A focus period specification frame 118 is displayed in the search result display field 114 in the example in FIG. 7. The focus period specification frame 118 is a frame used to specify a range of the medical care dates and times (referred to a “focus period”) of the documents displayed in the body schema portion 120. The left end of the focus period specification frame 118 indicates the start time of the focus period and the right end of the focus period specification frame 118 indicates the end time of the focus period. The positions of a start time mark 119s and an end time mark 119e of the focus period specification frame 118 are moved with an input device, such as a mouse, to vary the start time and the end time of the focus period. Position display marks 124a and 124b representing the documents the attribute values of the medical care dates and times of which are included in the focus period, among the documents that have been searched for, are displayed in the body schema portion 120.

Although the horizontal direction of the search result screen 100 corresponds to the direction of the time axis in the time line display in the example in FIG. 7, the vertical direction of the search result screen 100 may correspond to the direction of the time axis.

The time line portion 110 has been described above. Next, the body schema portion 120 will now be described.

A body schema 122 schematically indicating the appearance of the entire human body, viewed from the front face, is displayed in the body schema portion 120 in the example in FIG. 7. The position display marks 124a and 124b representing the documents or the document groups that have been searched for are arranged at the positions corresponding to the region codes (refer to FIG. 2) of the documents or the document groups on the body schema 122.

The square position display marks 124a are used when the number of the documents corresponding to the same region is one to four and the asterisk position display mark 124b is used when the number of the documents corresponding to the same region is five or more in the example in FIG. 7. In response to a predetermined operation on the position display mark by the user with the mouse or the like, for example, in response to pointing of a cursor on the position display mark 124a or 124b, a list of the documents that have been searched for and that correspond to the region indicated by the position display mark, (for example, a list of document names) is popped up. The document list may be a list in which the documents corresponding to the region are arranged in chronological order (or in reverse chronological order) of the medical care date and time. Other attributes including the medical care dates and times, the attending doctors, and the document types may also be displayed in the document list, in addition to the document names. In response to pointing of the cursor on any document in the document list and a predetermined operation, such as double-clicking, by the user, the document is opened and the content of the document is displayed on the screen.

Alternatively, in response to a predetermined operation on the position display mark, for example, in response to pointing of the cursor on the position display mark 124a or 124b, the time display mark 115a or 115b of each document corresponding to the position display mark may be highlighted in the time line portion 110.

The display mode of the position display mark may be varied depending on another attribute, such as the specialty attribute value of each document corresponding to the same region, instead of the number of the documents corresponding to the region. When multiple documents correspond to the same region, the display mode of the position display mark may be selected depending on a dominant attribute value (for example, the attribute value having the largest number of corresponding documents), among the attribute values of the multiple documents.

In the example in FIG. 7, a typical medical care date and time of the document group indicated by the position display mark is represented by the display density of the position display mark 124a or 124b. For example, the latest (or oldest) date and time, among the medical care dates and times of the documents included in the document group, may be used as the typical medical care date and time of the document group. The more recent the medical care date and time, the darker the display density of the position display mark in the example in FIG. 7. A density scale 126 indicating that the darker the display density, the more recent the medical care date and time is displayed in the body schema portion 120 as part of the legend. Instead of the display density, another display mode, such as the hue or the shape, of the position display mark may be used to represent the oldness (newness) of the medical care date and time.

Although the multiple documents corresponding to the same region are represented by one kind of the position display mark 124a or 124b in the example in FIG. 7, one document may be represented by one position display mark. In this case, among the display modes of the position display marks, a display mode other than the mode representing the oldness of the medical care date and time may be used to represent another attribute of the document. For example, the type of the document corresponding to each position display mark may be represented by the shape of the position display mark and the oldness of the medical care date and time corresponding to the document may be represented by the display density of the position display mark.

Instead of using the medical care record document as one unit as in the above example, the medical care record documents having the same medical care date and time and the same specialty may be used as one unit (this unit is referred to as a “medical care record unit”) and the display mode of the position display mark to be arranged on the region on the body schema may be differentiated depending on the number of medical care record units corresponding to the same region. For example, the square position display mark may be used when the number of the medical care record units corresponding to the same region is one to four and the asterisk position display mark may be used when the number medical care record units corresponding to the same region is five or more. The medical care record unit may be determined on the basis of the attributes of the medical care date and time and the specialty code of each document resulting from the search. Which region in the human body the medical care record unit corresponds to may be determined from the region codes of the documents included in the medical care record unit. As described above, using the medical care record documents having the same medical care date and time and the same specialty as one unit and visualizing the number of the medical care record units corresponding to the same region during a specified period allow the user to know that the number of times when the patient has received the medical care for the region during the period is large or small to some extent.

According to a modification, when the medical care identification information (the identification information commonly used in the series of medical cares from the first visit to the cure) is included in the management data about the documents, the medical care identification information in the management data about each document may be referred to integrate the medical care record documents used in the series of medical cares from the first visit to the cure of one symptom into one group. The display mode of the position display mark to be arranged in the same region on the body schema may be differentiated depending on the number of the groups corresponding to the region. For example, the square position display mark may be used when one group corresponds to the same region and the asterisk position display mark may be used when two or more groups correspond to the same region. Such display allows the user to know that the number of times when the patient has suffered illnesses or injuries for the region indicated by the position display mark is large or small to some extent.

When the number of the documents resulting from the search is large, displaying the position display marks representing the many documents on one body schema 122 makes the search result screen 100 complicated and it is difficult for the user to select a desired document. Accordingly, in one example, an upper limit (referred to as a “display upper limit”) may be set for the number of the documents to be displayed on one body schema 122. If the number of the documents resulting from the search exceeds the display upper limit, the documents may be sorted into multiple body schemas 122 for the display and the number of the documents in each body schema 122 may be set to a value lower than or equal to the display upper limit. In this case, for example, the multiple body schemas 122 may be arranged on the search result screen 100. The individual body schemas 122 are reduced in size so that the multiple body schemas 122 are fitted into one search result screen 100. Alternatively, for example, multiple search result screens 100 may be displayed and one body schema 122 (and a position display mark group arranged on the body schema 122) may be displayed on each search result screen 100. In this case, only the time display marks corresponding to the documents corresponding to the position display marks arranged on the body schema 122 may be displayed in the time line portion 110 on the search result screen 100.

The sorting of the documents into the multiple body schemas 122 is performed on the basis of, for example, the medical care time. In this example, the documents the number of which does not exceed the display upper limit are allocated to the first body schema 122 on the basis of the attribute of the medical care date and time of each document that has been searched for, for example, in reverse chronological order of the medical care date and time. If the documents that have not been allocated remain, the second body schema 122 may be prepared and the documents that have not been allocated are allocated to the second body schema 122 in reverse chronological order of the medical care date and time. Such processing is repeated until all the documents resulting from the search are allocated to any of the body schemas 122.

In another example, the documents may be sorted into different body schemas 122 for different specialties. In this example, the attribute of the specialty code of each document that has been searched for may be referred to separate the documents into groups for every specialty and the position display marks corresponding to the documents included in one group (the document group corresponding to one specialty) may be arranged on one body schema 122. If the number of the documents corresponding to one specialty exceeds the display upper limit of one body schema, the documents may be separated into multiple sub-groups (the number of the document in each sub-group is not exceed the display upper limit) in accordance with another attribute, such as the medical care date and time, and the respective sub-groups may be displayed on different body schemas 122. In this example, multiple specialties having a smaller number of documents may be integrated within a range meeting a condition that the sum of the number of the documents does not exceed the display upper limit on each body schema and the specialties may be allocated to one body schema 122.

Although the attribute of the medical care date and time or the attribute of the specialty is used as a reference to sort the documents resulting from the search into the multiple body schemas 122 in the above examples, the reference is not limited to the above ones. The documents may be separated into groups by using another document attribute and the groups may be allocated to the multiple body schemas 122.

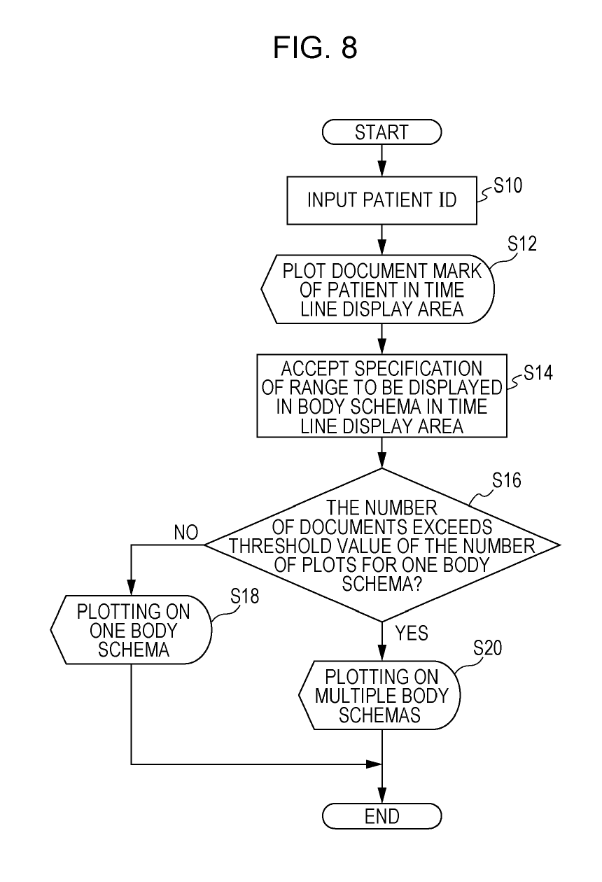

FIG. 8 is a flowchart illustrating an example of a process of searching and presenting the search result, performed by the medical care record management system 10.

Referring to FIG. 8, in Step S10, the user (for example, the doctor) inputs the patient ID as a search condition on the UI screen displayed in the terminal 40. The information management unit 16 in the medical care record management system 10, which has received the search condition, searches the medical care record management table 21 for documents corresponding to the patient ID. Information about the documents that have been searched for (the collection of the management data about the documents corresponding to the patient ID) is passed to the UI unit 14. In Step S12, the UI unit 14 generates the search result screen 100 in which the time display mark 115a or 115b corresponding to each document that is received is plotted at a position corresponding to the attribute value of the medical care date and time of the document in the search result display field 114 and supplies the generated search result screen 100 to the terminal 40. At this time, when different specialties are displayed in different rows in the search result display field 114 as in the example in FIG. 7, the time display mark 115a or 115b corresponding to each document is plotted on the row corresponding to the specialty code of the document. In Step S14, the UI unit 14 accepts specification of a period (that is, the “focus period”) to be displayed in the body schema portion 120 from the user. For example, the user specifies the start time and the end time of the focus period specification frame 118 (refer to FIG. 7) on the search result screen 100 to specify the focus period. In response to the specification from the user, information indicating the specified focus period (for example, information about the start time and the end time) is transmitted from the terminal 40 to the UI unit 14 in the medical care record management system 10. In Step S16, the UI unit 14 extracts the documents the medical care dates and times of which are within the focus period from the document group resulting from the search, calculates the number of the extracted documents, and determines whether the calculated number exceeds the display upper limit for one body schema.

If the number of documents corresponding to the focus period does not exceed the display upper limit for one body schema (NO in Step S16), in Step S18, the UI unit 14 generates the search result screen 100 in which the position display marks representing the extracted documents are plotted on the body schema 122 and transmits the generated search result screen 100 to the terminal 40. In this step, the UI unit 14 plots the position display mark corresponding to each extracted document at the position corresponding to the region code of the document on the body schema 122. The shape of the position display mark may be switched depending on the number of the documents corresponding to the same region or the display density of the position display mark may be varied depending on the medical care date and time of the document.

If the number of documents corresponding to the focus period exceeds the display upper limit for one body schema (YES in Step S16), in Step S20, the UI unit 14 sorts the extracted documents into the multiple body schemas 122 by the above method and plots the documents on the multiple body schemas 122. Then, the search result screen 100 (or multiple search result screens 100) including the multiple body schemas 122 after the plotting is transmitted to the terminal 40.

Although the search is performed by using the patient ID as the search condition in the example in FIG. 8, the search may be performed by using a combination of the patient ID and a condition of another document attribute with AND condition as the search condition.

As described above, the medical care record management system 10 of the present exemplary embodiment supplies the search result screen 100 in which the user is capable of viewing both the temporal distribution and the spatial distribution of the documents resulting from the search to the user. The user is capable of knowing the medical care history of the patient from both the spatial aspect and the temporal aspect on the search result screen 100.

While the exemplary embodiments of the invention have been described above, it will be recognized and understood that various modifications may be made in the invention.

For example, on the search result screen 100 exemplified in FIG. 7, the body schema 122 may be divided into multiple regions (for example, the head, the chest, the right arm, the left arm, and so on). In response to selection of one region from the multiple regions by a user's operation with the mouse or the like (for example, an operation to point the cursor on a desired region), the time display mark 115a or 115b of each document corresponding to the selected region in the time line portion 110 may be highlighted. This allows the user to confirm how often and when the medical cares have been performed for the corresponding region on the lime line.

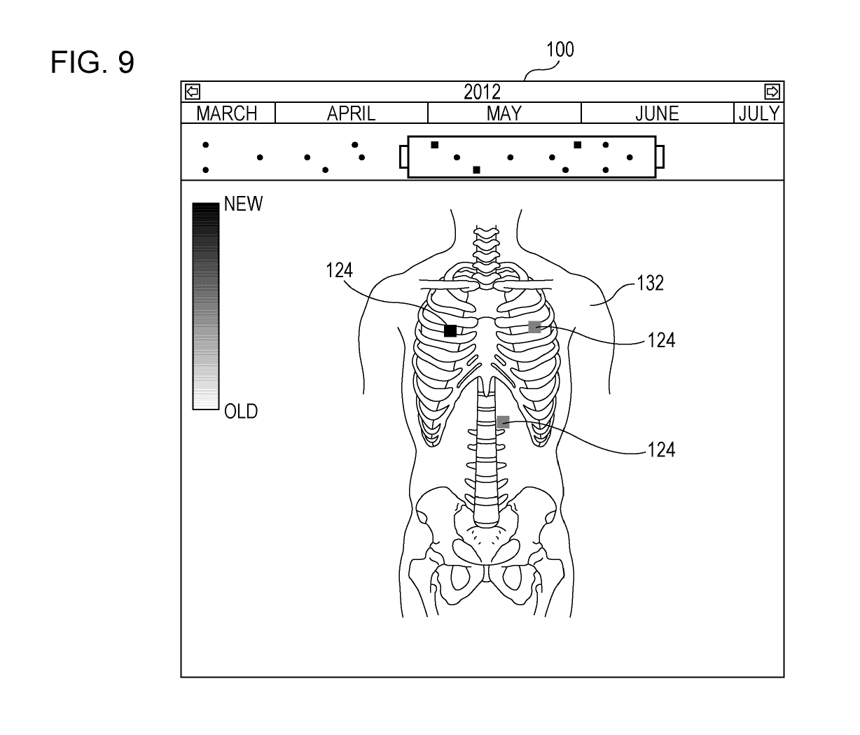

The body schema of a detailed region may be displayed in response to an operation to select a region on the body schema 122 of the entire human body displayed on the search result screen 100 or in response to an operation to select a region for which the detailed display is to be performed from a menu. FIG. 9 illustrates an example of the search result screen 100 in which a body schema 132 representing the skeleton of the trunk is displayed. In the example in FIG. 9, in response to an instruction to display the body schema 132, the UI unit 14 extracts each document the medical care region indicated by the region code of which is within the range represented by the body schema 132 from the documents resulting from the search and plots a position display mark 124 corresponding to the extracted document at a position indicated by the region code of the document on the body schema 132.

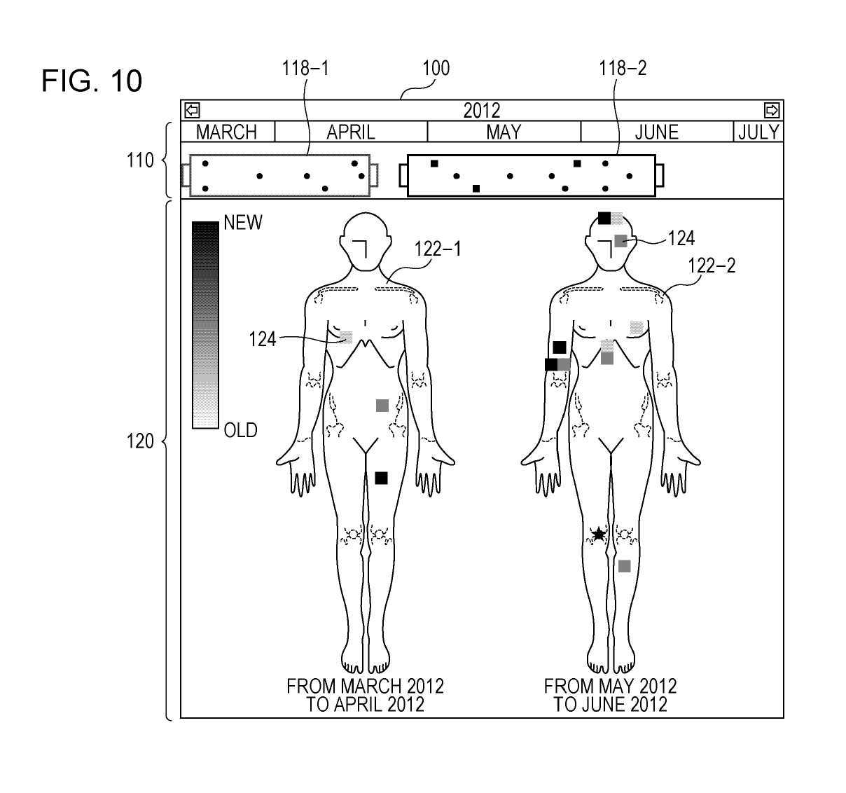

Although the specification of one focus period is accepted in the time line portion 110 on the search result screen 100 in the example in FIG. 7, specification of multiple focus periods may be accepted. In this case, the position display marks may be plotted on different body schemas 122 for different focus periods that are specified. FIG. 10 illustrates an example of the above plotting on the search result screen 100.

In the example in FIG. 10, two focus period specification frames 118-1 and 118-2 are specified in the time line portion 110 on the search result screen 100. Body schemas 122-1 and 122-2 corresponding to the two focus period specification frames 118-1 and 118-2, respectively, are displayed in the body schema portion 120. Specifically, the position display mark 124 corresponding to each document having the medical care date and time included in the period indicated by the focus period specification frame 118-1 as the attribute is plotted on the body schema 122-1, and the position display mark 124 corresponding to each document having the medical care date and time included in the period indicated by the focus period specification frame 118-2 as the attribute is plotted at the corresponding medical care region on the body schema 122-2.

Input of a search condition for refined search (for example, a keyword concerning the content of the document or a condition of the attribute of the document) may be accepted in a state in which the search result screen 100 exemplified in FIG. 7 or FIG. 10 is displayed. In this example, the information management unit 16 identifies the document corresponding to the search condition of the refined search, among the documents having the position display marks 124 plotted on the search result screen 100. The time display mark 115a or 115b and the position display mark 124a or 124b corresponding to the identified document are highlighted on the search result screen 100. For example, the doctor may perform the refined search on the basis of information acquired from a doctor's interview and/or medical examinations for the patient in a state in which the documents having the patient ID of the patient whom the doctor has charge of is displayed on the search result screen 100. The doctor selects a mark that is highlighted to access the document meeting the search condition of the refined search.

The spatial distribution of the medical care record documents at each time, for example, from the start time to the end time of the focus period indicated by the focus period specification frame 118 may be animated in, for example, the body schema portion 120 in response to an instruction from the user. For the animation display, for example, the focus period is divided for every predetermined unit period (for example, one week or one month), the documents the medical care dates and times of which belong to the unit period are identified from the documents resulting from the search for every unit period, and the identified documents are plotted on the body schema 122 (that is, are arranged at positions indicated by the region codes of the documents). Switching the body schema images for every unit period, which have been generated in the above manner, in time series for the display realizes the animation indicating the temporal transition of the spatial distribution of the medical care record documents.

The medical care record management system 10 exemplified above is realized by, for example, a general-purpose computer that executes programs representing the processing of the respective functional modules described above. The computer has, for example, a hardware circuit configuration in which a microprocessor, such as a central processing unit (CPU); memories (primary storages), such as a random access memory (RAM) and a read only memory (ROM); a hard disk drive (HDD) controller that controls an HDD; various input-output (I/O) interfaces; a network interface that performs control for connection to a network, such as a LAN; and so on are connected via, for example, a bus. In addition, a disk drive for reading from and/or writing into a portable disk recording medium, such as a compact disc (CD) or a digital versatile disk (DVD), a memory reader-writer for reading from and/or writing into portable non-volatile recording media conforming to various standards including a flash memory, and so on may be connected to the bus via, for example, the I/O interfaces. The programs in which the content of processing in the functional modules exemplified above is described are stored in a permanent storage, such as a hard disk drive, via the recording medium, such as the CD or the DVD, or via a communication unit, such as a network, and are installed in the computer. The programs stored in the permanent storage are read into the RAM and are executed by the microprocessor, such as the CPU, to realize the functional modules exemplified above. The components in the search result screen 100 exemplified above may be distributed to multiple computers that are capable of communicating with each other via a network for installation and the distributed components may be communicated with each other via the network to realize the functions of the medical care record management system 10.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program causing a computer to execute a process comprising:
searching a memory storing medical care record information about each patient including information about a medical care region and a medical care date and time for each piece of medical care record information about a specified patient; and
generating a distribution list image indicating distribution of the pieces of medical care record information that have been searched for,
wherein the generating generates the distribution list image in which a position distribution image and a time distribution image are arranged for display, the position distribution image having a position display mark that is associated with the medical care record information and that is arranged at each position corresponding to the medical care region in each piece of medical care record information that has been searched for on a body schema indicating a human body or part thereof, the time distribution image having a time display mark that is associated with the medical care record information and that is arranged at each position corresponding to the medical care date and time in each piece of medical care record information that has been searched for on a time axis.

2. The non-transitory computer readable medium according to claim 1,
wherein, if the number of the pieces of medical care record information that have been searched for exceeds a predetermined upper limit, the generating separates the pieces of medical care record information into display groups the number of the pieces of medical care record information in each of which does not exceed the upper limit according to a predetermined grouping rule and generates the position distribution image for every display group.

3. The non-transitory computer readable medium according to claim 1,
wherein the generating displays each position display mark on the position distribution image in a display mode corresponding to the medical care date and time corresponding to the medical care record information corresponding to the position display mark.

4. The non-transitory computer readable medium according to claim 2,
wherein the generating displays each position display mark on the position distribution image in a display mode corresponding to the medical care date and time corresponding to the medical care record information corresponding to the position display mark.

5. The non-transitory computer readable medium according to claim 1,
wherein, in response to specification of a part of the human body to be subjected to detailed display by a user on the position distribution image displayed in a display apparatus, the generating generates a partial position distribution image in which the position display mark corresponding to the medical care record information corresponding to the medical care region belonging to the part of the human body is arranged on a partial body schema corresponding to the specified part of the human body and displays the partial position distribution image on a display screen.

6. A medical care record display apparatus comprising:
a search unit that searches a memory storing medical care record information about each patient including information about a medical care region and a medical care date and time for each piece of medical care record information about a specified patient; and
an image generating unit that generates a distribution list image indicating distribution of the pieces of medical care record information that have been searched for,
wherein the image generating unit generates the distribution list image in which a position distribution image and a time distribution image are arranged for display, the position distribution image having a position display mark that is associated with the medical care record information and that is arranged at each position corresponding to the medical care region in each piece of medical care record information that has been searched for on a body schema indicating a human body or part thereof, the time distribution image having a time display mark that is associated with the medical care record information and that is arranged at each position corresponding to the medical care date and time in each piece of medical care record information that has been searched for on a time axis.

7. A non-transitory computer readable medium storing a program causing a computer to execute a process comprising:
searching a memory storing medical care record information about each patient including information about a medical care region and a medical care date and time for each piece of medical care record information about a specified patient; and
generating a position distribution image having a position display mark that is associated with the medical care record information and that is arranged at each position corresponding to the medical care region in each piece of medical care record information that has been searched for on a body schema indicating a human body or part thereof, the position display mark being displayed in a display mode corresponding to the medical care date and time in the medical care record information.

8. A medical care record display apparatus comprising:
a search unit that searches a memory storing medical care record information about each patient including information about a medical care region and a medical care date and time for each piece of medical care record information about a specified patient; and
an image generating unit that generates a position distribution image having a position display mark that is associated with the medical care record information and that is arranged at each position corresponding to the medical care region in each piece of medical care record information that has been searched for by the search unit on a body schema indicating a human body or part thereof, the position display mark being displayed in a display mode corresponding to the medical care date and time in the medical care record information.

9. A medical care record display method comprising:
searching a memory storing medical care record information about each patient including information about a medical care region and a medical care date and time for each piece of medical care record information about a specified patient; and
generating a distribution list image indicating distribution of the pieces of medical care record information that have been searched for,
wherein the generating generates the distribution list image in which a position distribution image and a time distribution image are arranged for display, the position distribution image having a position display mark that is associated with the medical care record information and that is arranged at each position corresponding to the medical care region in each piece of medical care record information that has been searched for on a body schema indicating a human body or part thereof, the time distribution image having a time display mark that is associated with the medical care record information and that is arranged at each position corresponding to the medical care date and time in each piece of medical care record information that has been searched for on a time axis.

10. A medical care record display method comprising:
searching a memory storing medical care record information about each patient including information about a medical care region and a medical care date and time for each piece of medical care record information about a specified patient; and
generating a position distribution image having a position display mark that is associated with the medical care record information and that is arranged at each position corresponding to the medical care region in each piece of medical care record information that has been searched for on a body schema indicating a human body or part thereof, the position display mark being displayed in a display mode corresponding to the medical care date and time in the medical care record information.
